(19) United States
(12) Patent Application Publication
(10) Pub. No.: US 2025/0259615 A1
(43) Pub. Date: Aug. 14, 2025

(54) SOUND ADJUSTMENT METHOD, SOUND ADJUSTMENT DEVICE, SOUND ADJUSTMENT SYSTEM, AND RECORDING MEDIUM

(71) Applicant: Panasonic Intellectual Property Management Co., Ltd., Osaka (JP)

(72) Inventors: Kotaro SAKATA, Osaka (JP); Tetsuji FUCHIKAMI, Osaka (JP)

(21) Appl. No.: 19/097,022

(22) Filed: Apr. 1, 2025

Related U.S. Application Data
(63) Continuation of application No. PCT/JP2023/032699, filed on Sep. 7, 2023.

(30) Foreign Application Priority Data
Oct. 17, 2022 (JP) 2022-166102

(51) Int. Cl. G10K 11/178; G06F 3/16

(52) U.S. Cl. CPC G10K 11/17823; G06F 3/165

(57) ABSTRACT

A sound adjustment method includes: estimating a user situation of a user who is using, out of a first space and a second space that are adjacent to each other, the first space; determining a usage situation by determining, based on the user situation of the user who is using the first space estimated, whether the first space is being used for work by a plurality of workers including the user who is using the first space; and adjusting sound propagation by switching, based on a determination result made in the determining of the usage situation, between whether or not to apply noise cancellation that reduces a listening level at which a sound generated in one of the first space or the second space is heard in another one of the first space or the second space.

### CROSS REFERENCE TO RELATED APPLICATIONS

This is a continuation application of PCT International Application No. PCT/JP2023/032699 filed on Sep. 7, 2023, designating the United States of America, which is based on and claims priority of Japanese Patent Application No. 2022-166102 filed on Oct. 17, 2022. The entire disclosures of the above-identified applications, including the specifications, drawings and claims are incorporated herein by reference in their entirety.

### FIELD

The present disclosure relates to a sound adjustment method, a sound adjustment device, a sound adjustment system, and a recording medium.

### BACKGROUND

Patent Literature (PTL) 1 discloses a technique regarding an in-vehicle soundproof structure capable of switching between a soundproof state and a non-soundproof state.

### CITATION LIST

### Patent Literature

PTL 1: Japanese Unexamined Patent Application Publication No. 2019-137358

### SUMMARY

### Technical Problem

In PTL 1 described above, the switching between the soundproof state and the non-soundproof state is usually performed based on vehicle state. However, there are cases where, depending on the situation of the space to which the soundproof structure is applied, the switching between the soundproof state and the non-soundproof state based on the vehicle state is not performed appropriately.

To address the above, the present disclosure provides a sound adjustment method and the like that can more appropriately switch between whether or not to allow a sound to pass through between two spaces.

### Solution to Problem

A sound adjustment method according to one aspect of the present disclosure includes: estimating a user situation of a user who is using, out of a first space and a second space that are adjacent to each other, the first space; determining a usage situation by determining, based on the user situation of the user who is using the first space estimated, whether the first space is being used for work by a plurality of workers including the user who is using the first space; and adjusting sound propagation by switching, based on a determination result made in the determining of the usage situation, between whether or not to apply noise cancellation that reduces a listening level at which a sound generated in one of the first space or the second space is heard in another one of the first space or the second space.

Also, a sound adjustment device according to one aspect of the present disclosure includes: a situation estimator that estimates a user situation of a user who is using, out of a first space and a second space that are adjacent to each other, the first space; a usage situation determiner that determines, based on the user situation of the user who is using the first space estimated, whether the first space is being used for work by a plurality of workers including the user who is using the first space; and a sound propagation adjuster that switches, based on a determination result made by the usage situation determiner, between whether or not to apply noise cancellation that reduces a listening level at which a sound generated in one of the first space or the second space is heard in another one of the first space or the second space.

Also, a sound adjustment system according to one aspect of the present disclosure includes: a first microphone that picks up a sound in a first space; a second microphone that picks up a sound in a second space adjacent to the first space; a first loudspeaker that outputs a sound in the first space; a second loudspeaker that outputs a sound in the second space; a sound adjustment device; and a control device, wherein the sound situation estimator that adjustment device includes: a estimates a user situation of a user who is using the first space; a usage situation determiner that determines, based on the user situation of the user who is using the first space estimated, whether the first space is being used for work by a plurality of workers including the user who is using the first space; and a sound propagation adjuster that switches, based on a determination result made by the usage situation determiner, between whether or not to apply noise cancellation that reduces a listening level at which a sound generated in one of the first space or the second space is heard in another one of the first space or the second space, and the control device controls the first microphone, the second microphone, the first loudspeaker, and the second loudspeaker according to the switching between whether or not to apply the noise cancellation by the sound propagation adjuster.

Generic or specific aspects of the present disclosure may be implemented by a device, an integrated circuit, a computer program, or a non-transitory recording medium such as a computer-readable compact disc-read only memory (CD-ROM), or any given combination thereof.

### Advantageous Effects

According to the sound adjustment method and the like of the present disclosure, it is possible to more appropriately switch between whether or not to allow a sound to pass through between two spaces.

### BRIEF DESCRIPTION OF DRAWINGS

These and other advantages and features will become apparent from the following description thereof taken in conjunction with the accompanying drawings, by way of non-limiting examples of embodiments disclosed herein.

FIG. 1 is a diagram illustrating spaces to which a sound adjustment system according to an embodiment is applied.

FIG. 2 is a diagram showing an example of how the sound adjustment system according to the embodiment is used.

FIG. 3 is a block diagram showing an example of a hardware configuration of the sound adjustment system according to the embodiment.

FIG. 4 is a flowchart illustrating an example of an operation performed by the sound adjustment system according to the embodiment.

FIG. 5 is a diagram showing a first example of sound adjustment implemented by the sound adjustment system according to the embodiment.

FIG. 6 is a diagram showing a second example of sound adjustment implemented by the sound adjustment system according to the embodiment.

FIG. 7 is a diagram showing a third example of sound adjustment implemented by the sound adjustment system according to the embodiment.

FIG. 8 is a diagram showing a fourth example of sound adjustment implemented by the sound adjustment system according to the embodiment.

FIG. 9 is a diagram showing a fifth example of sound adjustment implemented by the sound adjustment system according to the embodiment.

FIG. 10 is a diagram showing a sixth example of sound adjustment implemented by the sound adjustment system according to the embodiment.

### DESCRIPTION OF EMBODIMENT

### (Underlying Knowledge Forming Basis of the Present Disclosure)

In recent years, the concept of free addressing and the like has become increasingly popular, and thus the number of cases where people can choose their own comfortable working place in their office to do tasks such as work is increasing. Furthermore, more people are not only working in their office, but also in a telework environment in which they can work remotely from anywhere such as home, a location outside the office, a resort area, and a public space by connecting to the office or the like via a network such as the Internet without going to the office. Furthermore, a hybrid work environment in which in-office working and teleworking are combined is gaining acceptance. Under the circumstances described above, there are increasing needs to create a workspace, a common workspace, or the like in the limited available space at home or in the office. Accordingly, a case may occur in which a workspace and a non-workspace are adjacent to each other. In this case, a problem arises such as leakage of sound and the like from one of the adjacent spaces to the other space, and vice versa. In other words, a sound generated in one of the adjacent spaces may propagate to the other space via a boundary portion (for example, a wall) between the adjacent spaces, and heard by a user who is using the other space. There is also another problem in that the usage of one of the spaces may be changed over time such as, for example, from a workspace to a non-workspace.

For example, in the case where, during a meeting or the like in one of adjacent spaces, when noise and the like from the other space propagate, the propagated noise and the like are mixed with the voice in the meeting, which may interfere with the meeting. The listening level of the sound or noise from the other space can be reduced by applying ordinary noise cancellation. As another example, there may be a case where one of the adjacent spaces is used as a solo workspace on a different day. More specifically, there may be a case where one of the adjacent spaces is used for a remote meeting over a network from home on one day, and used as a solo work booth at home on a different day. In the case of a remote meeting over a network, because the above-described problem arises, it is favorable to reduce the sound or noise from the other space. However, there is also a need to allow a sound to propagate to one of adjacent spaces from the other space when, for example, a child is playing in the other space, to determine whether care needs to be taken for the child.

To address the problems described above, in the present disclosure, a sound adjustment method and the like will be described in which, in order to more appropriately implement switching between whether or not to allow a sound, such as voice, to pass through between two spaces, a determination is made, based on the usage situation of one of the two spaces or the like, as to whether or not to reduce the listening level of the sound from the other space, or in other words, whether or not to apply noise cancellation. The expression “not allow a sound such as voice to pass through” used in the present disclosure means to reduce the listening level of the propagated sound. Accordingly, the expression “whether or not to allow a sound to pass through” refers to a concept that means whether or not to allow the sound to propagate without applying noise cancellation, or more strictly whether the sound propagation level is reduced to zero or whether the listening level is relatively reduced as compared with that before applying the noise cancellation.

### SUMMARY OF DISCLOSURE

A summary of the disclosure will be given below.

A sound adjustment method according to a first aspect of the present disclosure includes: estimating a user situation of a user who is using, out of a first space and a second space that are adjacent to each other, the first space; determining a usage situation by determining, based on the user situation of the user who is using the first space estimated, whether the first space is being used for work by a plurality of workers including the user who is using the first space; and adjusting sound propagation by switching, based on a determination result made in the determining of the usage situation, between whether or not to apply noise cancellation that reduces a listening level at which a sound generated in one of the first space or the second space is heard in another one of the first space or the second space.

With this configuration, the switching between whether or not to apply the noise cancellation can be performed based on the determination result made as to whether the first space is being used for work by a plurality of workers. The noise cancellation is applied when it is determined that, for example, the first space is being used for work by a plurality of workers such as a meeting. Accordingly, it is possible to more appropriately switch between whether or not to allow a sound to pass through between two spaces.

Also, a sound adjustment method according to a second aspect of the present disclosure is the sound adjustment method according to the first aspect, wherein the noise cancellation includes first noise cancellation that reduces a listening level at which a sound generated in the second space is heard in the first space.

With this configuration, due to the application of the noise cancellation, the listening level at which the sound generated in the second space is heard in the first space can be reduced.

Also, a sound adjustment method according to a third aspect of the present disclosure is the sound adjustment method according to the first or second aspect, wherein the noise cancellation includes second noise cancellation that reduces a listening level at which a sound generated in the first space is heard in the second space.

With this configuration, due to the application of the noise cancellation, the listening level at which the sound generated in the first space is heard in the second space can be reduced.

Also, a sound adjustment method according to a fourth aspect of the present disclosure is the sound adjustment method according to any one of the first to third aspects, further including: determining situation confidentiality by determining, based on the user situation of the user who is using the first space estimated, whether the user who is using the first space has the situation confidentiality, wherein, in the adjusting, the switching between whether or not to apply the noise cancellation is performed also based on whether the user who is using the first space has the situation confidentiality.

With this configuration, the switching between whether or not to apply the noise cancellation can be performed further based on the determination result made as to whether the user who is using the first space has the situation confidentiality.

Also, a sound adjustment method according to a fifth aspect of the present disclosure is the sound adjustment method according to the fourth aspect, wherein, in the estimating of the user situation, as the user situation of the user who is using the first space, whether the user is doing a task is determined, and in the determining of the situation confidentiality, it is determined that the user who is using the first space has the situation confidentiality when the user situation of the user who is using the first space estimated indicates that the user is doing a task.

With this configuration, when the user who is using the first space is doing a task, it is determined that the user has the situation confidentiality, and thus the switching between whether or not to apply the noise cancellation can be performed further based on the determination result.

Also, a sound adjustment method according to a sixth aspect of the present disclosure is the sound adjustment method according to any one of the first to fifth aspects, further including: estimating a user attribute of the user who is using the first space; and determining attribute confidentiality by determining, based on the user attribute of the user who is using the first space estimated, whether the user who is using the first space has the attribute confidentiality, wherein, in the adjusting, the switching between whether or not to apply the noise cancellation is performed also based on whether the user who is using the first space has the attribute confidentiality.

With this configuration, the switching between whether or not to apply the noise cancellation can be performed further based on the determination result made as to whether the user who is using the first space has the attribute confidentiality.

Also, a sound adjustment method according to a seventh aspect of the present disclosure is the sound adjustment method according to the sixth aspect, wherein the estimating of the user attribute includes estimating, as the user attribute of the user who is using the first space, affiliation information of each of all the plurality of workers who are involved in the work in the first space, and in the determining of the attribute confidentiality, it is determined that the user who is using the first space has the attribute confidentiality when not all the plurality of workers have identical affiliation information.

With this configuration, when not all the plurality of workers who are involved in the work in the first space have identical affiliation information, it is determined that the user who is using the first space has the attribute confidentiality, and thus the switching between whether or not to apply the noise cancellation can be performed further based on the determination result.

Also, a sound adjustment method according to an eighth aspect of the present disclosure is the sound adjustment method according to the sixth aspect, wherein the estimating of the user attribute includes estimating, as the user attribute of the user who is using the first space, whether the user who is using the first space is a child, and in the determining of the attribute confidentiality, it is determined that the user who is using the first space does not have the attribute confidentiality when it is estimated that the user who is using the first space is a child.

With this configuration, when the user who is using the first space is a child, it is determined that the user who is using the first space has the attribute confidentiality, and thus the switching between whether or not to apply the noise cancellation can be performed further based on the determination result.

Also, a sound adjustment method according to a ninth aspect of the present disclosure is the sound adjustment method according to any one of the sixth to eighth aspects, further including: determining situation confidentiality by determining whether the user who is using the first space estimated has the situation confidentiality, wherein, in the adjusting, the noise cancellation is applied when a determination result made in the determining of the usage situation indicates that the first space is being used for the work; and the switching between whether or not to apply the noise cancellation is performed based on whether the user who is using the first space has the situation confidentiality and whether the user who is using the first space has the attribute confidentiality when the determination result made in the determining of the usage situation indicates that the first space is not being used for the work.

With this configuration, when the first space is being used for the work by the plurality of workers, the noise cancellation is applied. When the first space is not being used for the work by the plurality of workers, the switching between whether or not to apply the noise cancellation can be performed further based on the determination result made as to whether the user who is using the first space has the situation confidentiality and the determination result made as to whether the user who is using the first space has the attribute confidentiality.

Also, a sound adjustment method according to a tenth aspect of the present disclosure is the sound adjustment method according to the ninth aspect, wherein the noise cancellation includes first noise cancellation that reduces a listening level at which a sound generated in the second space is heard in the first space and second noise cancellation that reduces a listening level at which a sound generated in the first space is heard in the second space, and, in the adjusting, the first noise cancellation is applied when the determination result made in the determining of the usage situation indicates that the first space is being used for the work; and switching between whether or not to apply the second noise cancellation is performed based on whether the user who is using the first space has the situation confidentiality and whether the user who is using the first space has the attribute confidentiality when the determination result made in the determining of the usage situation indicates that the first space is not being used for the work.

With this configuration, when the first space is being used for the work by the plurality of workers, the first noise cancellation is applied. When the first space is not being used for the work by the plurality of workers, the switching between whether or not to apply the noise cancellation can be performed further based on the determination result made as to whether the user who is using the first space has the situation confidentiality and the determination result made as to whether the user who is using the first space has the attribute confidentiality.

Also, a sound adjustment method according to an eleventh aspect of the present disclosure is the sound adjustment method according to any one of the first to tenth aspects, wherein, in the determining of the usage situation, it is determined that the first space is not being used for the work when the work is interrupted.

With this configuration, when the work is interrupted, it is determined that the first space is not being used for the work, and thus the switching between whether or not to apply the noise cancellation can be performed further based on the determination result.

Also, a sound adjustment method according to a twelfth aspect of the present disclosure is the sound adjustment method according to the eleventh aspect wherein the work includes: sound pick-up of picking up a sound including voice emitted from one or more workers in the first space including the user who is using the first space, out of the plurality of workers; and remote sound output of outputting the sound picked up to a space different from the first space via a network, the sound output being heard by one or more workers in the space different from the first space out of the plurality of workers, and the interruption of the work includes muting the sound picked up in the first space.

With this configuration, when sound pick-up of picking up a sound including voice emitted from one or more workers in the first space including the user who is using the first space, out of the plurality of workers and remote sound output of outputting the sound picked up to a space different from the first space via a network are performed, the sound output is heard by one or more workers in the space different from the first space out of the plurality of workers, and the work is interrupted by muting the sound picked up in the first space, it is determined that the first space is not being used for the work, and thus the switching between whether or not to apply the noise cancellation can be performed based on the determination result.

Also, a sound adjustment method according to a thirteenth aspect of the present disclosure is the sound adjustment method according to any one of the first to twelfth aspects, further including: presenting an alternative by, when switching is performed to apply the noise cancellation in the adjusting, outputting, based on the sound whose listening level is reduced, content that the sound is intended to mean as an image.

With this configuration, when a problem of allowing the sound to pass through occurs, the content that the sound is intended to mean can be recognized by viewing the output image while suppressing the problem.

Also, a recording medium according to a fourteenth aspect of the present disclosure is a non-transitory computer-readable recording medium having recorded thereon a program for causing a computer to execute the sound adjustment method according to any one of the first to thirteenth aspects.

With this configuration, the same advantageous effects as those of the sound adjustment method described above can be obtained using a computer.

Also, a sound adjustment device according to a fifteenth aspect of the present disclosure includes: a situation estimator that estimates a user situation of a user who is using, out of a first space and a second space that are adjacent to each other, the first space;

a usage situation determiner that determines, based on the user situation of the user who is using the first space estimated, whether the first space is being used for work by a plurality of workers including the user who is using the first space; and a sound propagation adjuster that switches, based on a determination result made by the usage situation determiner, between whether or not to apply noise cancellation that reduces a listening level at which a sound generated in one of the first space or the second space is heard in another one of the first space or the second space.

With this configuration, the same advantageous effects as those of the sound adjustment method described above can be obtained.

Also, a sound adjustment system according to a sixteenth aspect of the present disclosure includes: a first microphone that picks up a sound in a first space; a second microphone that picks up a sound in a second space adjacent to the first space; a first loudspeaker that outputs a sound in the first space; a second loudspeaker that outputs a sound in the second space; a sound adjustment device; and a control device, wherein the sound adjustment device includes: a situation estimator that estimates a user situation of a user who is using the first space; a usage situation determiner that determines, based on the user situation of the user who is using the first space estimated, whether the first space is being used for work by a plurality of workers including the user who is using the first space; and a sound propagation adjuster that switches, based on a determination result made by the usage situation determiner, between whether or not to apply noise cancellation that reduces a listening level at which a sound generated in one of the first space or the second space is heard in another one of the first space or the second space, and the control device controls the first microphone, the second microphone, the first loudspeaker, and the second loudspeaker according to the switching between whether or not to apply the noise cancellation by the sound propagation adjuster.

With this configuration, the same advantageous effects as those of the sound adjustment method described above can be obtained.

These general and specific aspects may be implemented using a device, an integrated circuit, a computer program, or a non-transitory recording medium such as a computer-readable CD-ROM, or any given combination thereof.

Hereinafter, an embodiment will be described in detail with reference to the accompanying drawings as appropriate. However, unnecessarily detailed description may be omitted. For example, detailed explanation of a well-known matter and repeated description of substantially identical structures may be omitted. Such omission makes the following description exclude unnecessary redundancy and be easily understood by those skilled in the art.

It should be noted that the accompanying drawings and the following description are provided by the inventors of the present application to facilitate sufficient understanding of the present disclosure by those skilled in the art, and are thus not intended to limit the scope of the subject matter recited in the claims.

### Embodiment

### [Configuration]

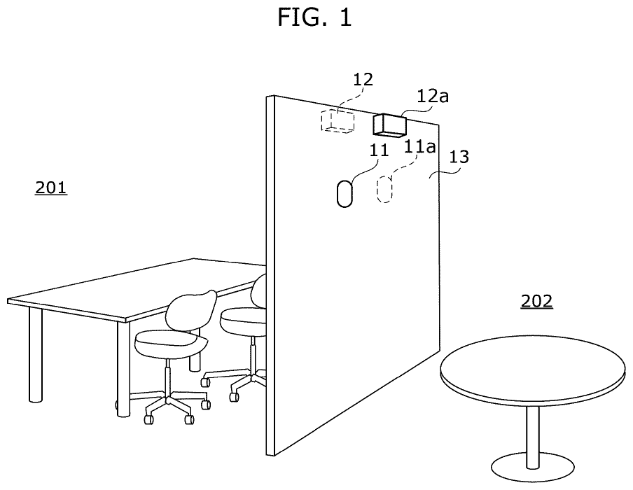

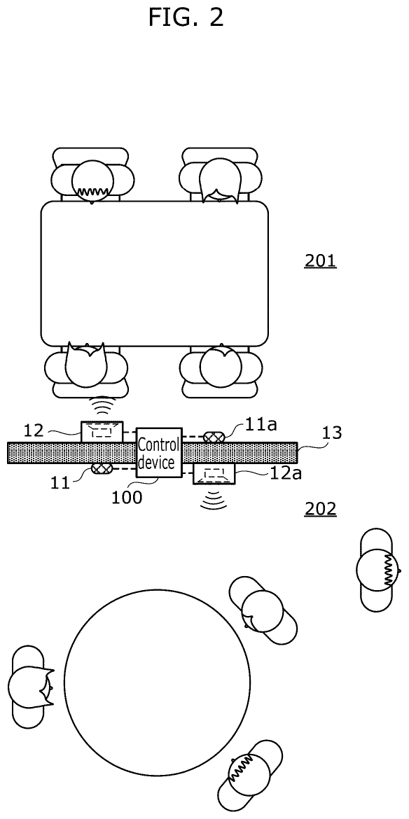

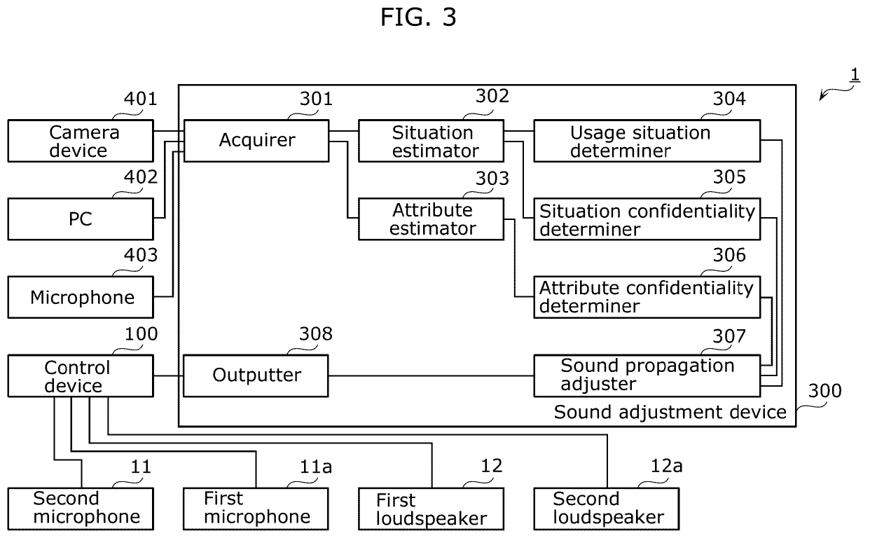

FIG. 1 is a diagram illustrating spaces to which a sound adjustment system according to an embodiment is applied. FIG. 2 is a diagram showing an example of how the sound adjustment system according to the embodiment is used. Note that FIG. 2 shows a top view of the spaces to which sound adjustment system 1 (see FIG. 3, which will be described below) is applied.

FIGS. 1 and 2 show first space 201 and second space 202 that are adjacent to each other and separated by partition 13. Partition 13 is an example of a boundary that separates first space 201 and second space 202 from each other. First space 201 and second space 202 may be separated by portable partition 13, a fixed wall, or the like. Also, first space 201 and second space 202 do not necessarily need to be physically separated, and may be conceptually separated. That is, a continuous space may be separated into first space 201 and second space 202 based on a boundary without being physically separated.

Partition 13 provided as the boundary between first space 201 and second space 202 includes first loudspeaker 12 directed toward first space 201 and second loudspeaker 12a directed toward second space 202. First microphone 11a is directed toward first space 201, and second microphone 11 is directed toward second space 202. First space 201 is, for example, a space that can be used by one or more people as a work place (workspace). For example, first space 201 is used by a user in first space 201 to do a task. The task may be work that is done by the individual user (solo work) or a meeting of a plurality of participants (also referred to as “workers”) including the user in first space 201. Second space 202 is, for example, a space that is used in a shared manner by an unspecified number of people such as a lobby where people come and go and that can be used as a temporary rest area.

FIG. 2 shows a portion of sound adjustment system 1 that includes control device 100, first microphone 11a, second microphone 11, first loudspeaker 12, and second loudspeaker 12a. Although a detailed description of sound adjustment system 1 will be given later with reference to FIG. 3 and the like, sound adjustment system 1 includes, in addition to the above-described structural elements, sound adjustment device 300 (see FIG. 3, which will be described later) that is connected to control device 100 and the like via a network, and some other devices.

First microphone 11a is provided on first space 201 side of partition 13. First microphone 11a detects a sound generated in first space 201. First microphone 11a does not necessarily need to be attached to partition 13 as long as it is possible to detect a sound generated in first space 201. First microphone 11a may be attached to the ceiling, a wall, or the floor of first space 201, or may be attached to a desk, a table, a chair, or the like placed in first space 201.

Second microphone 11 is provided on second space 202 side of partition 13. Second microphone 11 detects a sound generated in second space 202. Second microphone 11 does not necessarily need to be attached to partition 13 as long as it is possible to detect a sound generated in second space 202. Second microphone 11 may be attached to the ceiling, a wall, or the floor of second space 202, or may be attached to a desk, a table, a chair, or the like placed in second space 202.

First loudspeaker 12 is provided on first space 201 side of partition 13. First loudspeaker 12 is used for noise cancellation (first noise cancellation) by outputting a sound that makes it difficult for people in first space 201 to hear the sound generated in second space 202. Here, the sound generated in second space 202 includes, for example, a conversation between users in second space 202, a movement sound of users in second space 202, operating noise of equipment installed in second space 202, and the like. The conversation between users in second space 202 may be a conversation between a plurality of users in second space 202 or a conversation via voice call between a user in second space 202 and a user outside second space 202 (or in other words, a user who is in a separate space) using communication terminals. First loudspeaker 12 may include a loudspeaker array that includes a plurality of loudspeaker units arranged in a specific direction, and may be capable of controlling directivity toward a specific direction.

Second loudspeaker 12a is provided on second space 202 side of partition 13. Second loudspeaker 12a is used for noise cancellation (second noise cancellation) by outputting a sound that makes it difficult for people in second space 202 to hear the sound generated in first space 201. Here, the sound generated in first space 201 includes, for example, a conversation between users in first space 201, a movement sound of users in first space 201, operating noise of equipment installed in first space 201, and the like. The conversation between users in first space 201 may be a conversation between a plurality of users in first space 201 or a conversation via voice call between a user in first space 201 and a user outside first space 201 (or in other words, a user who is in a separate space) using communication terminals. Second loudspeaker 12a may include a loudspeaker array that includes a plurality of loudspeaker units arranged in a specific direction, and may be capable of controlling directivity toward a specific direction.

Second microphone 11 and first loudspeaker 12 may be provided by adjusting the positions or orientations of second microphone 11 and first loudspeaker 12 such that second microphone 11 is unlikely to pick up a sound emitted from first loudspeaker 12. Likewise, first microphone 11a and second loudspeaker 12a may be provided by adjusting the positions or orientations of first microphone 11a and second loudspeaker 12a such that first microphone 11a is unlikely to pick up a sound emitted from second loudspeaker 12a.

Also, second microphone 11 and first loudspeaker 12 may be provided by adjusting the sound volume of first loudspeaker 12 or the sensitivity of second microphone 11 such that second microphone 11 is unlikely to pick up a sound emitted from first loudspeaker 12. Likewise, first microphone 11a and second loudspeaker 12a may be provided by adjusting the sound volume of second loudspeaker 12a or the sensitivity of first microphone 11a such that first microphone 11a is unlikely to pick up a sound emitted from second loudspeaker 12a.

First microphone 11a, second microphone 11, first loudspeaker 12, and second loudspeaker 12a do not necessarily need to be attached to partition 13 as long as they are provided such that second microphone 11 is unlikely to pick up a sound emitted from first loudspeaker 12 and first microphone 11a is unlikely to pick up a sound emitted from second loudspeaker 12a.

Control device 100 acquires a detection result from second microphone 11, and generates a sound for first noise cancellation according to the acquired detection result such as a phase inversion sound output from first loudspeaker 12. Likewise, control device 100 acquires a detection result from first microphone 11a, and generates a sound for second noise cancellation according to the acquired detection result such as a phase inversion sound output from second loudspeaker 12a.

Next, a specific configuration of sound adjustment system 1 will be described.

FIG. 3 is a block diagram showing an example of a hardware configuration of the sound adjustment system according to the embodiment.

As shown in FIG. 3, sound adjustment system 1 includes, as hardware structural elements, camera device 401, PC 402, microphone 403, sound adjustment device 300, control device 100, first microphone 11a, second microphone 11, first loudspeaker 12, and second loudspeaker 12a.

Sound adjustment device 300 is implemented by, for example, a cloud server on a network or an edge server installed in a building to which first space 201 and second space 202 belong. Sound adjustment device 300 includes, for example, a processor, a main memory, a storage, and a communication interface (IF) that are not shown in FIG. 3.

The processor is a processor that executes programs stored in the storage or the like.

The main memory is a volatile storage area that is used to temporarily store data generated during processing performed by the processor, used as a work area by the processor when executing the programs, or used to temporarily store data received by the communication IF.

The storage is a non-volatile storage device that stores various types of data such as data of the programs. The storage stores, for example, various types of data generated as a result of the processor performing processing.

The communication IF is a communication interface for transmitting data to an external device via a communication network.

Sound adjustment device 300 includes acquirer 301, situation estimator 302, attribute estimator 303, usage situation determiner 304, situation confidentiality determiner 305, attribute confidentiality determiner 306, sound propagation adjuster 307, and outputter 308 as shown in FIG. 3 as functional structural elements that function as a result of various types of programs being executed by the processor, the main memory, the storage, and the communication IF. In other words, sound adjustment device 300 includes programs for implementing the above-described functional structural elements in addition to the processor, the main memory, the storage, and the communication IF.

Acquirer 301 is connected to camera device 401, PC 402, and microphone 403, and acquires estimation information for situation estimation and attribute estimation from these devices. As used herein, the term “estimation information for situation estimation and attribute estimation” refers to, for example, image information in first space 201 acquired from camera device 401 installed in first space 201, an operation log of PC 402 acquired from PC 402 carried into first space 201, sound information in first space 201 acquired from microphone 403 installed in first space 201, and the like. First microphone 11a may also function as microphone 403. Sound adjustment system 1 does not necessarily include all of camera device 401, PC 402, and microphone 403.

The information for situation estimation and attribute estimation is acquired by acquirer 301 and output to situation estimator 302 and attribute estimator 303.

Situation estimator 302 estimates a user situation of a user who is using first space 201. The user situation of the user who is using first space 201 refers to information that indicates whether the user is doing a task such as work. For the situation estimation, for example, the operation log acquired from PC 402 is used. Situation estimator 302 estimates that the user is doing a task when the user is using PC 402 to do some kind of task (operating an application or the like). A result of estimation performed by situation estimator 302 is output to usage situation determiner 304 and situation confidentiality determiner 305.

Attribute estimator 303 estimates a user attribute of the user who is using first space 201. The user attribute of the user who is using first space 201 refers to information regarding an organizational attribute (an affiliation attribute), a social attribute, or the like of the user. For the attribute estimation, for example, an image acquired from camera device 401 is used. Attribute estimator 303 estimates, if the user (for example, the user's face) matches a registered user, that the user belongs to an organization, and if the user matches none of the registered users, estimates that the user belongs to a different organization. A result of estimation performed by attribute estimator 303 is output to attribute confidentiality determiner 306.

For the attribute estimation, for example, a sound from microphone 403 may also be used. Attribute estimator 303 estimates, if the user (for example, the user's voice and the content that the user's voice is intended to mean) satisfies a predetermined condition, that the user is a child, and if the user does not satisfy the predetermined condition, estimates that the user is not a child.

Usage situation determiner 304 determines whether first space 201 is being used for work by a plurality of workers. A determination result made is output to sound propagation adjuster 307. The work by a plurality of workers may be, for example, a conversation taking place in first space 201, or a remote conversation (a so-called online meeting) that requires bidirectional remote sound output.

The remote sound output means that a sound picked up (recorded) in one space is transmitted via a network and output (reproduced) in a separate space such as, for example, voice in one space is heard in a separate space.

For example, a remote conversation between first space 201 and a separate space is performed as a result of a voice emitted from one or more workers in first space 201 including the user who is using first space 201 out of a plurality of workers being picked up (recorded), the picked-up sound being output (reproduced) in the separate space different from first space 201 via a network, a voice emitted from one or more workers in the separate space (not shown) out of the plurality of workers being picked up (recorded), and the pick-up sound being output (reproduced) in first space 201 via the network.

In the remote conversation described above, due to the remote sound output from first space 201 to the separate space, the output sound is heard in the separate space. For example, when noise generated in second space 202 is propagated from second space 202 to first space 201, due to the remote sound output, the noise is also heard in the separate space. As described above, the propagation of sound from second space 202 to first space 201 may interfere with the work by the plurality of workers.

Situation confidentiality determiner 305 determines, based on the result of estimation performed by situation estimator 302, whether the user who is using first space 201 has situation confidentiality that indicates that the situation of the user who is using first space 201 is confidential. A determination result made is output to sound propagation adjuster 307. Situation confidentiality determiner 305 determines that the user who is using first space 201 has the situation confidentiality when, for example, the user who is using first space 201 is doing a task. If situation confidentiality determiner 305 determines that the user who is using first space 201 has the situation confidentiality, there is a possibility that a sound that needs to be kept confidential (should not be leaked) may be generated in first space 201, and the sound should not be heard by a user in second space 202. That is, the propagation of sound from first space 201 to second space 202 is not favorable in terms of confidentiality.

Attribute confidentiality determiner 306 determines, based on the result of estimation performed by attribute estimator 303, whether the user who is using first space 201 has attribute confidentiality that indicates that the attribute of the user who is using first space 201 needs to be kept confidential. A determination result made is output to sound propagation adjuster 307. Attribute confidentiality determiner 306 determines that the user who is using first space 201 has the attribute confidentiality if, for example, the users who are using first space 201 include a user with a different affiliation, or in other words, not all of the users who are using first space 201 have identical affiliation information. If attribute confidentiality determiner 306 determines that the user who is using first space 201 has the attribute confidentiality, there is a possibility that a conversation that needs to be kept confidential (should not be leaked) may take place in first space 201. As an example, it is assumed that first space 201 and second space 202 belong to company A, and a staff member of company A and a staff member of company B that is different from company A are having a meeting in first space 201. In this case, it is not favorable that a speech made by the staff member of company B is heard by a staff member of company A who happens to be in second space 202. The same applies to the case where, for example, staff members of company A who belong to different departments are having a meeting in first space 201. As described above, if it is determined that the user who is using first space 201 has the attribute confidentiality, a sound generated in first space 201 should not be heard by a user who is using second space 202. That is, the propagation of sound from first space 201 to second space 202 is not favorable in terms of confidentiality.

On the other hand, for example, in the case where the user who is using first space 201 is a child, attribute confidentiality determiner 306 determines that the user who is using first space 201 does not have the attribute confidentiality. An example will be described in which two spaces in a house are defined as first space 201 and second space 202. It is assumed that, in the house, a child is in first space 201, and a guardian of the child is teleworking in second space 202. In this case, a sound generated in first space 201 is the resultant from the child's behavior such as speaking. The child's behavior may include a behavior that requires immediate attention from the guardian, and the sound of which needs to be heard by the user who is using second space 202. That is, there is a case where the propagation of sound from first space 201 to second space 202 is necessary.

Sound propagation adjuster 307 switches, based on the determination results made by usage situation determiner 304, situation confidentiality determiner 305, and attribute confidentiality determiner 306, between whether or not to apply noise cancellation that reduces the listening level at which the sound generated in one of first space 201 or second space 202 is heard in the other one of first space 201 or second space 202. More specifically, sound propagation adjuster 307 switches, based on the determination result made by usage situation determiner 304, between whether or not to apply first noise cancellation that reduces the listening level at which the sound generated in second space 202 is heard in first space 201. Also, sound propagation adjuster 307 switches, based on the determination results made by situation confidentiality determiner 305 and attribute confidentiality determiner 306, between whether or not to apply second noise cancellation that reduces the listening level at which the sound generated in first space 201 is heard in second space 202. When the switching between whether or not to apply the noise cancellation is performed, sound propagation adjuster 307 outputs, to outputter 308, a control signal for performing the control.

Outputter 308 is connected to control device 100, and transmits the control signal output from sound propagation adjuster 307 to control device 100.

Control device 100 controls first microphone 11a, second microphone 11, first loudspeaker 12, and second loudspeaker 12a in accordance with the control signal so as to selectively control whether or to apply the first noise cancellation, or whether or not to apply the second noise cancellation.

### [Operation]

Next, an operation performed by sound adjustment system 1 according to the embodiment will be described.

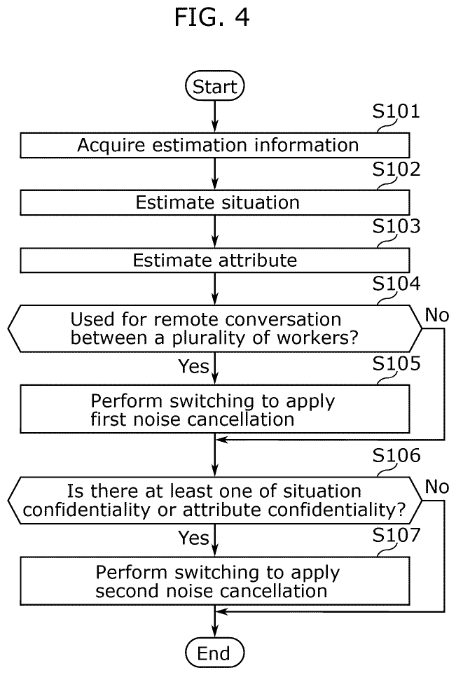

FIG. 4 is a flowchart illustrating an example of an operation performed by the sound adjustment system according to the embodiment.

First, acquirer 301 acquires estimation information for situation estimation and attribute estimation from camera device 401, PC 402, microphone 403, and the like (S101).

Next, situation estimator 302 estimates the user situation of a user who is using first space 201 (situation estimating step S102). Also, attribute estimator 303 estimates the attribute of the user who is using first space 201 (attribute estimating step S103).

Next, usage situation determiner 304 determines whether first space 201 is being used for work (in this example, a remote conversation) by a plurality of workers (usage situation determining step S104). Specifically, usage situation determiner 304 determines whether first space 201 is being used for a remote conversation by a plurality of workers based on whether one or more PCs 402 are running in first space 201 and connected to one or more PCs in a separate space via a predetermined remote conversation application. If it is determined by usage situation determiner 304 that first space 201 is being used for a remote conversation by a plurality of workers (Yes in S104), the processing proceeds to step S105. If it is determined by usage situation determiner 304 that first space 201 is not being used for a remote conversation by a plurality of workers (No in S104), the processing proceeds to step S106.

In step S105, sound propagation adjuster 307 outputs a control signal for switching to apply the first noise cancellation, and outputter 308 transmits the control signal to control device 100. Then, in control device 100, the first noise cancellation is applied by generating an anti-phase sound from the sound picked up by second microphone 11 and causing first loudspeaker 12 to reproduce the sound. If the first noise cancellation has already been applied, control device 100 maintains the first noise cancellation, and controls second microphone 11 and first loudspeaker 12.

In step S106, situation confidentiality determiner 305 determines whether the user who is using the first space has situation confidentiality (situation confidentiality determining step), and attribute confidentiality determiner 306 determines whether the user who is using the first space has attribute confidentiality (attribute confidentiality determining step) so as to determine whether the user who is using the first space has at least one of the situation confidentiality or the attribute confidentiality. If it is determined that the user who is using the first space has at least one of the situation confidentiality or the attribute confidentiality (Yes in S106), the processing proceeds to step S107. If it is determined that the user who is using the first space has none of the situation confidentiality or the attribute confidentiality (No in S106), the processing ends.

In step S107, sound propagation adjuster 307 outputs a control signal for switching to apply the second noise cancellation, and outputter 308 transmits the control signal to control device 100. Then, in control device 100, the second noise cancellation is applied by generating an anti-phase sound from the sound picked up by first microphone 11a and causing second loudspeaker 12a to reproduce the sound. If the second noise cancellation has already been applied, control device 100 maintains the second noise cancellation, and controls first microphone 11a and second loudspeaker 12a. Steps S105 and S107 may also be collectively referred to as “sound propagation adjusting step”.

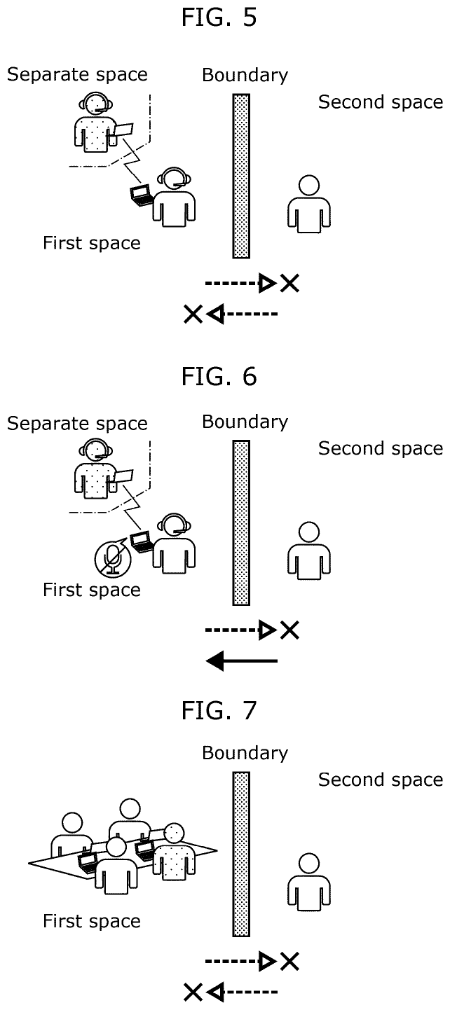

Hereinafter, specific examples that are results of the above-described operation will be described with reference to FIGS. 5 to 10. FIGS. 5 to 10 are diagrams showing first to sixth examples of sound propagation adjustment implemented by the sound adjustment system according to the embodiment. In each diagram, a first space and a second space are shown. When a sound propagates through a boundary that separates the first space and the second space from each other, a solid arrow indicating the propagation direction of the sound is shown. Also, when a sound does not propagate through the boundary (when noise cancellation is applied), a broken arrow indicating the propagation direction of the sound and a cross mark at the end of the broken arrow are shown.

In the example shown in FIG. 5, a user in a first space is having a remote conversation with a user in a separate space. Accordingly, Yes is determined in usage situation determining step S104. Here, the user in the separate space has a different affiliation from that of the user in the first space. In the diagram, a user with a different affiliation is hatched. The same applies to FIGS. 6 to 10 shown below. In the example shown in FIG. 5, it is determined that the user who is using the first space has the attribute confidentiality, and thus Yes is determined in step S106. As a result, in the example shown in FIG. 5, the listening level of the sound that propagates from the second space to the first space is reduced by the first noise cancellation, and the listening level of the sound that propagates from the first space to the second space is reduced by the second noise cancellation.

Here, when the listening level of the propagating sound is reduced by the noise cancellation, or in other words, in the above-described example, when switching is performed to apply the noise cancellation in the sound propagation adjusting step, a case may occur in which the content that the propagating sound is intended to mean needs to be conveyed, without propagating the sound. For example, an inconvenient case may occur in which, if an urgent contact needs to be taken between users in the first space and the second space due to the occurrence of a high priority task or the like, with the noise cancellation being applied, it is difficult to perform communication by sound. To address this problem, an example will be described by assuming that, due to the application of the noise cancellation, the listening level of a sound transmitted from the second space to the first space is reduced. For example, an image may be displayed (presented) on the PC or the like of the user who is using the first space by converting, based on the sound whose listening level is reduced, the context of the sound into text information using a voice recognition model or the like to generate the image indicating the text information, and outputting the generated image. This configuration works effectively in the above-described case because the context of the sound can be conveyed while suppressing interference with the remote conversation caused by the propagation of the sound.

In the example shown in FIG. 6, a user in a first space is having a remote conversation with a user in a separate space, but the sound picked up in the first space is muted. When the sound picked up in the first space is muted, it is determined that the work (the remote conversation) is interrupted. When the remote conversation is interrupted, it is determined that the first space is not used for the remote conversation, and thus No is determined in usage situation determining step S104. Here, the user in the separate space has a different affiliation from that of the user in the first space. For this reason, in the example shown in FIG. 6, it is determined that the user in the first space has the attribute confidentiality, and thus Yes is determined in step S106. As a result, in the example shown in FIG. 6, the sound generated in the second space propagates to the first space because the first noise cancellation is not applied, and the sound generated in the first space propagates to the second space with its listening level being reduced by the second noise cancellation.

In the example shown in FIG. 7, a plurality of users are doing work (in this example, a conversation that is not a remote conversation) in a first space, and thus Yes is determined in usage situation determining step S104. Also, the plurality of users in the first space include a user with a different affiliation from that of the other users. Accordingly, in the example shown in FIG. 7, it is determined that the user who is using the first space has the attribute confidentiality, and thus Yes is determined in step S106. As a result, in the example shown in FIG. 7, the listening level of the sound that propagates from the second space to the first space is reduced by the first noise cancellation, and the listening level of the sound that propagates from the first space to the second space is reduced by the second noise cancellation.

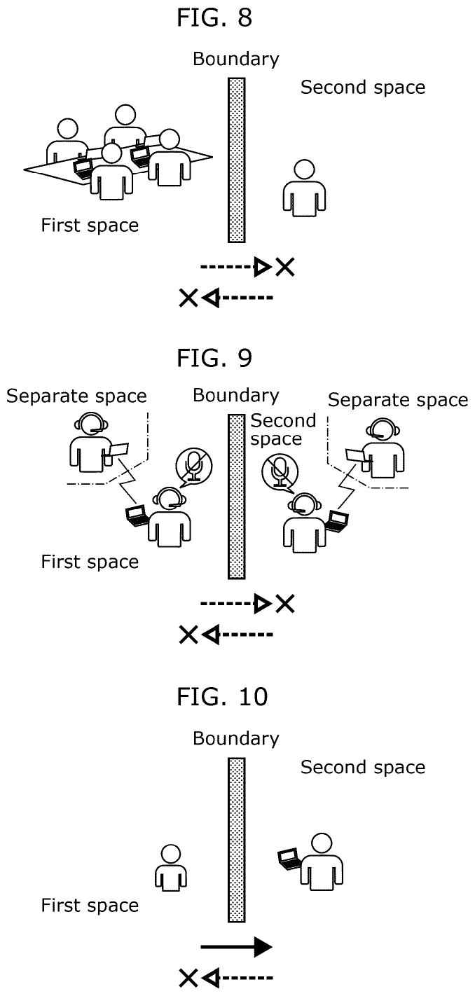

In the example shown in FIG. 8, a plurality of users are having a conversation in a first space, and thus Yes is determined in usage situation determining step S104. Also, the plurality of users in the first space do not include a user with a different affiliation. Accordingly, in the example shown in FIG. 8, it is determined that the user who is using the first space does not have the attribute confidentiality. However, the user in the first space is doing a task, Yes is determined in step S106. As a result, in the example shown in FIG. 8, the listening level of the sound that propagates from the second space to the first space is reduced by the first noise cancellation, and the listening level of the sound that propagates from the first space to the second space is reduced by the second noise cancellation. Here, a configuration may be used in which, for example, without providing situation confidentiality determiner 305, only whether the user who is using the first space has the attribute confidentiality is determined in step S106. With this configuration, No is determined in step S106, and thus the sound generated in the first space can propagate from the first space to the second space, without applying the second noise cancellation.

In the example shown in FIG. 9, as in FIG. 5, a user in a first space is having a remote conversation with a user in a separate space. Accordingly, Yes is determined in usage situation determining step S104. In a second space as well, as in FIG. 5, a user in the second space is having a remote conversation with a user in a separate space. Here, it is assumed, in the example shown in FIG. 9, that two different sound adjustment systems including a sound adjustment system for the first space and a sound adjustment system for the second space (hereinafter referred to as “second sound adjustment system”) are used. That is, as viewed from the second sound adjustment system, the first space shown in FIG. 9 corresponds to the second space that is adjacent to the first space. Furthermore, it is also assumed that, in the example shown in FIG. 9, that situation confidentiality determiner 305 is not provided, and only whether the user who is using the first space has the attribute confidentiality is determined in step S106. In the example shown in FIG. 9, the users in the separate spaces have the same affiliation with that of the user in the first space, and thus it is determined that the user who is using the first space does not have the attribute confidentiality. Accordingly, Yes is determined in step S106. Note that, in the second sound adjustment system, Yes is determined in usage situation determining step S104. Accordingly, as a result, the listening level of the sound that propagates from the second space to the first space is reduced by the first noise cancellation of the sound adjustment system for the first space, and the listening level of the sound that propagates from the first space to the second space is reduced by the first noise cancellation of the second sound adjustment system.

In the example shown in FIG. 10, a child is in a first space as a user, and a user in a second space is doing a task. Here, in the example shown in FIG. 10 as well, as in FIG. 9, it is assumed that two different sound adjustment systems including a sound adjustment system for the first space and a second sound adjustment system are used. In the first space, no task is being done by the user, and no work by a plurality of workers is being performed. Accordingly, No is determined in usage situation determining step S104, and thus it is determined that the user who is using the first space does not have the attribute confidentiality. Accordingly, No is determined in step S106. On the other hand, in the second sound adjustment system, the user is doing a task, but no work by a plurality of workers is being performed. Accordingly, No is determined in usage situation determining step S104, and thus it is determined that the user who is using the first space has the situation confidentiality. Accordingly, Yes is determined in step S106. Based on these results, in the example shown in FIG. 10, the listening level of the sound that propagates from the second space to the first space is reduced by the second noise cancellation of the second sound adjustment system, and the sound that propagates from the first space to the second space propagates as is because neither the second noise cancellation of the sound adjustment system for the first space nor the first noise cancellation of the second sound adjustment system is applied.

### Other Embodiments

An example was shown in which the sound adjustment device according to the embodiment is implemented by a cloud server or an edge server. However, the sound adjustment device according to the embodiment may be implemented by, for example, a dedicated information processing device provided in the first space or the second space. The dedicated information processing device may be included in the partition. With the configuration in which the dedicated information processing device is included in the partition as the sound adjustment device, together with the first and second microphones and the first and second loudspeakers, it is possible to implement a partition-type sound adjustment system.

Also, each of the structural elements in the embodiment given above may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory.

Also, the structural elements may be circuits (or an integrated circuit). The circuits may constitute a single circuit as a whole, or may be separate circuits. Also, the circuits may be general-purpose circuits or dedicated circuits.

Also, the general and specific aspects of the present disclosure may be implemented using a system, a device, a method, an integrated circuit, a computer program, or a non-transitory recording medium such as a computer-readable CD-ROM, or any given combination thereof.

For example, the present disclosure may be implemented as a sound adjustment method executed by a sound adjustment device (a computer or a DSP), or as a program for causing a computer or a DSP to execute the sound adjustment method.

Also, in the embodiment given above, a processing operation performed by a specific processor may be performed by a different processor. Also, the order of a plurality of processing operations performed by the sound adjustment system described in the embodiment given above may be changed. The plurality of processing operations may be performed in parallel.

The present disclosure also encompasses other embodiments obtained by making various modifications that can be conceived by a person having ordinary skill in the art to the above embodiment as well as embodiments implemented by any combination of the structural elements and the functions of the above embodiment without departing from the scope of the present disclosure.

### INDUSTRIAL APPLICABILITY

The present disclosure is useful as a sound adjustment system or the like for providing a sound environment appropriate for a user who is using a space.

1. A sound adjustment method comprising:
estimating a user situation of a user who is using, out of a first space and a second space that are adjacent to each other, the first space;
determining a usage situation by determining, based on the user situation of the user who is using the first space estimated, whether the first space is being used for work by a plurality of workers including the user who is using the first space; and
adjusting sound propagation by switching, based on a determination result made in the determining of the usage situation, between whether or not to apply noise cancellation that reduces a listening level at which a sound generated in one of the first space or the second space is heard in another one of the first space or the second space.

2. The sound adjustment method according to claim 1,
wherein the noise cancellation includes first noise cancellation that reduces a listening level at which a sound generated in the second space is heard in the first space.

3. The sound adjustment method according to claim 1,
wherein the noise cancellation includes second noise cancellation that reduces a listening level at which a sound generated in the first space is heard in the second space.

4. The sound adjustment method according to claim 1, further comprising:
determining situation confidentiality by determining, based on the user situation of the user who is using the first space estimated, whether the user who is using the first space has the situation confidentiality,
wherein, in the adjusting, the switching between whether or not to apply the noise cancellation is performed also based on whether the user who is using the first space has the situation confidentiality.

5. The sound adjustment method according to claim 4,
wherein, in the estimating of the user situation, as the user situation of the user who is using the first space, whether the user is doing a task is determined, and
in the determining of the situation confidentiality, it is determined that the user who is using the first space has the situation confidentiality when the user situation of the user who is using the first space estimated indicates that the user is doing a task.

6. The sound adjustment method according to claim 1, further comprising:
estimating a user attribute of the user who is using the first space; and
determining attribute confidentiality by determining, based on the user attribute of the user who is using the first space estimated, whether the user who is using the first space has the attribute confidentiality,
wherein, in the adjusting, the switching between whether or not to apply the noise cancellation is performed also based on whether the user who is using the first space has the attribute confidentiality.

7. The sound adjustment method according to claim 6,
wherein the estimating of the user attribute includes estimating, as the user attribute of the user who is using the first space, affiliation information of each of all the plurality of workers who are involved in the work in the first space, and
in the determining of the attribute confidentiality, it is determined that the user who is using the first space has the attribute confidentiality when not all the plurality of workers have identical affiliation information.

8. The sound adjustment method according to claim 6,
wherein the estimating of the user attribute includes estimating, as the user attribute of the user who is using the first space, whether the user who is using the first space is a child, and
in the determining of the attribute confidentiality, it is determined that the user who is using the first space does not have the attribute confidentiality when it is estimated that the user who is using the first space is a child.

9. The sound adjustment method according to claim 6, further comprising:
determining situation confidentiality by determining whether the user who is using the first space estimated has the situation confidentiality,
wherein, in the adjusting,
the noise cancellation is applied when a determination result made in the determining of the usage situation indicates that the first space is being used for the work; and
the switching between whether or not to apply the noise cancellation is performed based on whether the user who is using the first space has the situation confidentiality and whether the user who is using the first space has the attribute confidentiality when the determination result made in the determining of the usage situation indicates that the first space is not being used for the work.

10. The sound adjustment method according to claim 9,
wherein the noise cancellation includes first noise cancellation that reduces a listening level at which a sound generated in the second space is heard in the first space and second noise cancellation that reduces a listening level at which a sound generated in the first space is heard in the second space, and
in the adjusting,
the first noise cancellation is applied when the determination result made in the determining of the usage situation indicates that the first space is being used for the work; and
switching between whether or not to apply the second noise cancellation is performed based on whether the user who is using the first space has the situation confidentiality and whether the user who is using the first space has the attribute confidentiality when the determination result made in the determining of the usage situation indicates that the first space is not being used for the work.

11. The sound adjustment method according to claim 1,
wherein, in the determining of the usage situation, it is determined that the first space is not being used for the work when the work is interrupted.

12. The sound adjustment method according to claim 11,
wherein the work includes: sound pick-up of picking up a sound including voice emitted from one or more workers in the first space including the user who is using the first space, out of the plurality of workers; and remote sound output of outputting the sound picked up to a space different from the first space via a network, the sound output being heard by one or more workers in the space different from the first space out of the plurality of workers, and
the interruption of the work includes muting the sound picked up in the first space.

13. The sound adjustment method according to claim 1, further comprising:
presenting an alternative by, when switching is performed to apply the noise cancellation in the adjusting, outputting, based on the sound whose listening level is reduced, content that the sound is intended to mean as an image.

14. A non-transitory computer-readable recording medium having recorded thereon a program for causing a computer to execute the sound adjustment method according to claim 1.

15. A sound adjustment device comprising:
a situation estimator that estimates a user situation of a user who is using, out of a first space and a second space that are adjacent to each other, the first space;
a usage situation determiner that determines, based on the user situation of the user who is using the first space estimated, whether the first space is being used for work by a plurality of workers including the user who is using the first space; and
a sound propagation adjuster that switches, based on a determination result made by the usage situation determiner, between whether or not to apply noise cancellation that reduces a listening level at which a sound generated in one of the first space or the second space is heard in another one of the first space or the second space.

16. A sound adjustment system comprising:
a first microphone that picks up a sound in a first space;
a second microphone that picks up a sound in a second space adjacent to the first space;
a first loudspeaker that outputs a sound in the first space;
a second loudspeaker that outputs a sound in the second space;
a sound adjustment device; and
a control device,
wherein the sound adjustment device includes:
a situation estimator that estimates a user situation of a user who is using the first space;
a usage situation determiner that determines, based on the user situation of the user who is using the first space estimated, whether the first space is being used for work by a plurality of workers including the user who is using the first space; and
a sound propagation adjuster that switches, based on a determination result made by the usage situation determiner, between whether or not to apply noise cancellation that reduces a listening level at which a sound generated in one of the first space or the second space is heard in another one of the first space or the second space, and
the control device controls the first microphone, the second microphone, the first loudspeaker, and the second loudspeaker according to the switching between whether or not to apply the noise cancellation by the sound propagation adjuster.
